(19) United States
(12) Patent Application Publication
(10) Pub. No.: US 2025/0007043 A1
(43) Pub. Date: Jan. 2, 2025

(54) BATTERY CASING SHELL WITH IMPROVED TEMPERATURE RESISTANCE FOR A TRACTION BATTERY

(71) Applicant: KAUTEX TEXTRON GmbH & Co. KG, Bonn (DE)

(72) Inventors: Nicolay Bergmann, Aachen (DE); Sammy Metsahel, Bonn (DE); Mario Strack, Bonn (DE); Yuxiao Pan, Shanghai (CN); Xin Meng, Shanghai (CN)

(21) Appl. No.: 18/709,155

(22) PCT Filed: Oct. 6, 2022
(86) PCT No.: PCT/EP2022/077848

§ 371 Date: May 10, 2024

(30) Foreign Application Priority Data
Nov. 10, 2021 (DE) 10 2021 129 273.5

(51) Int. Cl. H01M 10/658; B29C 43/18; B29L 31/34; B60L 50/64; H01M 50/227; H01M 50/249; H01M 50/293

(52) U.S. Cl. CPC H01M 10/658; B29C 43/18; B60L 50/64; H01M 50/227; H01M 50/249; H01M 50/293; B29C 2043/181; B29L 2031/3468; H01M 2220/20

(57) ABSTRACT

A battery housing shell for a battery housing of a traction battery for accommodating at least one battery component in a battery housing volume. A wall of the battery housing shell at least partially limits the battery housing volume and the wall of the battery housing shell is at least partially formed from a plastic. The battery housing shell includes a high-temperature-resistant protective device that is at least partially form-fit engaged from behind by the wall of the battery housing shell.

The present invention relates to a battery housing shell for a battery housing of a traction battery of a motor vehicle. Furthermore, the present invention relates to a traction battery and a motor vehicle with a traction battery. Furthermore, the present invention relates to an apparatus and a method of producing a battery housing shell.

A battery, in particular a traction battery for energy storage in a motor vehicle, consists of a large number of components. One of the tasks of a traction battery housing is to secure and protect battery components in the form of battery modules and/or cooling modules and the like.

In hybrid vehicles and/or electric vehicles, electrochemical energy storage systems with a high voltage and/or high energy density are predominantly used, in particular in the form of lithium-ion batteries, whereby the amount of energy that can be stored per unit volume (energy density) increases with the further development of the used electrochemical energy storage systems.

If a local short circuit of the internal electrodes occurs in an electrochemical energy storage device, in particular in a lithium-ion accumulator with liquid, solid or bound electrolyte, the short circuit current can heat up the immediate vicinity of the short circuit location due to the internal resistance to such an extent that the battery housing shell or the battery housing comprising the battery housing shell and the surrounding areas are also affected. This process can expand and release the energy stored in the battery in the form of heat in a short time, especially the stored electrical and chemical energy. This release of heat often proceeds exponentially and is also referred to as thermal irreversible escalation or thermal runaway, or more generally as a thermal event.

The thermal stability of electrochemical energy storage devices is often inversely proportional to the amount of energy stored per unit volume, which means that thermal stability is becoming increasingly important in the development of new electrochemical energy storage devices.

In particularly for battery housing shells or battery casings made of plastic there is a need to increase their thermal stability so that they can better withstand thermal stress.

The object of the present invention is to provide a battery housing shell comprising an improved temperature resistance and also low manufacturing costs.

The object of the present invention is solved by a battery housing shell with the features of claim 1. Advantageous embodiments of the battery housing shell are described in the claims dependent on claim 1.

More specifically, the object of the present invention is solved by a battery housing shell for a battery housing of a traction battery for accommodating at least one battery component in a battery housing volume, wherein a wall of the battery housing shell at least partially limits the battery housing volume and the wall of the battery housing shell is at least partially formed from a plastic. The battery housing shell is characterized in that the battery housing shell comprises a high-temperature-resistant protective device wherein the protective device is at least partially form-fit engaged from behind by the wall of the battery housing shell.

The battery housing shell according to the invention has the advantage that it has improved temperature resistance and also low manufacturing costs, so that the manufacturing time or the cycle time for producing the battery housing shell is exceptionally short. This is because the high-temperature-resistant protective device is positioned and, if necessary, fixed in a tool part for producing the battery housing shell during the manufacturing process of the battery housing shell in such a way that, when the battery housing shell is formed, the high-temperature-resistant protective device is surrounded or overflowed by the housing material of the battery housing shell, so that the high-temperature-resistant protective device is at least partially engaged from behind by the wall of the battery housing shell. A further advantage is that the protective device does not have to be screwed and/or glued to the battery housing shell in a separate work step.

The protective device can consist of a single component or can be made up of a plurality of components.

The battery component is, for example, a battery module, a cooling module, a fluid line or the like. There are no restrictions according to the invention in this regard.

The battery housing volume is the volume which is at least partially limited by the battery housing shell. The battery housing volume may also be referred to as the battery housing receiving space.

The battery housing shell comprises, for example, a thermoplastic material, in particular polyamide and/or polyetheretherketone and/or acryl-butadiene-styrene and/or polyethylene and/or polypropylene.

The battery housing shell can alternatively and/or additionally comprise a thermosetting plastic, for example epoxy resin and/or polyester resin.

A high-temperature-resistant protective device is understood to mean a protective device which is designed in such a way that it is not completely melted and/or decomposed, in particular up to a temperature of 400° C., preferably 700° C., more preferably 1000° C., when the protective device is exposed to this temperature for a period of 10 seconds, preferably for a period of 30 seconds, more preferably for a period of 60 seconds, more preferably for a period of 300 seconds, more preferably again for a period of 600 seconds and particularly preferably for a period of more than 10 minutes. The protective device is therefore dimensionally stable when exposed to the heat defined above.

The protective device comprises, for example, a high-temperature-resistant plastic, a metal, a ceramic or a glass. Preferably, the protective device is formed at least partially from a mineral layered silicate, for example from mica.

The high-temperature-resistant protective device is designed, for example, as a protective plate. The protective plate is, for example, flat so that the normal vectors on a flat surface of the protective plate are aligned parallel to each other. This flat surface may face the battery housing volume. Furthermore, it is also possible that a, or the flat surface of the protective plate faces an outer side of the battery housing shell.

The high-temperature-resistant protective device can also be designed such that a surface of the protective device facing the battery housing volume has a three-dimensional shape. Consequently, not all normal vectors of this surface are parallel to each other.

For example, the protective device is shaped in such a way that one direction of expansion is significantly smaller than the other two directions of expansion, so that the two larger directions of expansion describe a planar extension of the protective device.

The two larger dimensions of the protective device form, for example, a square, rectangular, triangular or other polygonal shape. Alternatively, a round, elliptical or other oval shape is also possible.

The protective device comprises, for example, a thickness in the range between 0.5 mm and 5 mm, further, for example, in the range between 0.8 mm and 4 mm, further, for example, in the range between 1 mm and 3 mm.

The high-temperature-resistant protective device, for example, is form-fit connected to the battery housing shell. In another example, the protective device is additionally or alternatively materially connected to the battery housing shell.

Since the protective device is at least partially engaged from behind by the wall of the battery housing shell, the protective device is essentially not displaceable relative to the wall of the battery housing shell. This means that the protective device cannot be moved relative to the wall at all or can only be moved in one direction by a few millimetres, preferably less than 2 millimetres, more preferably less than 1 millimetre.

For example, the protective device is engaged from behind by the wall of the battery housing shell in such a way that at least 2-5 mm in the flat plane of the protective device are engaged from behind by the wall of the battery housing shell. Furthermore, the material of the wall of the battery housing shell protrudes, for example, between 0.5 mm and 1 mm in the direction of the smaller extension on the protective device.

Preferably, the battery housing shell comprises a plurality of protective devices. The plurality of protective devices is, for example, arranged in a symmetrical pattern or freely distributed. This can in increased thermal and/or mechanical resistance of the battery housing shell.

The protective device can also be called an insert.

Preferably, the battery housing shell is formed such that the at least one wall is formed at least partially from a fiber-reinforced plastic.

The plastic is reinforced, for example, with glass fibres and/or carbon fibres and/or aramid fibres.

The fiber material reinforcing the plastic can, for example, be formed as a fiber material, wherein the fiber material comprises, for example, medium-length fibers and/or long fibers with a length between 1 mm and 50 mm.

The correspondingly formed battery housing shell is manufactured, for example, by means of an extrusion process. The extrusion process is particularly suitable for the molding/processing of fiber-reinforced plastics, especially of long-fiber-reinforced plastics.

Preferably, the battery housing shell is formed such that it comprises at least one holding device which is formed monolithically with the wall.

The holding device is formed, for example, as a retaining clip which is monolithically connected to the wall. The wall is consequently formed such that the holding device or the holding clamp is formed integrally with the wall.

A monolithic connection/formation of the at least one holding device with the wall is to be understood as meaning that the holding device and the wall consist of one piece or one component. The at least one holding device and the wall are therefore continuous and seamless. For example, the battery housing shell and thus also the wall of the battery housing shell together with the at least one holding device are manufactured by means of extrusion or injection molding, wherein an extrusion tool or an injection molding tool is formed such that during the manufacture of the battery housing shell the wall is formed together with the at least one holding device.

Preferably, the battery housing shell is formed such that an outer edge of the protective device at least partially comprises a bevel, wherein the at least one bevel of the protective device is at least partially engaged from behind by the wall.

For example, an outer edge or several outer edges can be beveled in sections, wherein the protective device is engaged from behind by the wall in the region of the beveled areas of the outer edge or the outer edges.

The protective device comprises, for example, a circumferential or partially circumferential bevel on the circumferential outer edge. Alternatively, the protective device comprises, for example, interrupted regular or irregular sections, each of which alternates between a section with a bevel and a section without a bevel on the peripheral outer edge.

Preferably, the battery housing shell is formed such that at least one protective device is arranged on an inner side that is facing the battery housing volume and/or at least one protective device is arranged on an outer side of the wall of the battery housing shell that is facing away from the battery housing volume.

Preferably, the battery housing shell is formed such that the at least one protective device is embedded flatly in the wall of the battery housing shell, so that the wall comprises a flat surface without unevenness.

By such a forming of the battery housing shell, the battery housing volume is better suited to accommodate battery components.

Preferably, the battery housing shell is formed such that the protective device comprises a layered silicate and/or mica and/or metal and/or steel and/or plastic and/or fiber-reinforced plastic.

Furthermore, an object of the present invention is providing a battery housing which comprises improved temperature resistance and also low manufacturing costs.

This object underlying the present invention is solved by a battery housing with the features of claim 7. More specifically, this object underlying the present invention is achieved by a battery housing of a traction battery for accommodating at least one battery component in a battery housing volume, wherein the battery housing is characterized in that the battery housing has a battery housing shell as described above.

The battery housing comprises, for example, a second battery housing shell which is designed corresponding to the battery housing shell now referred to as the first battery housing shell. The first battery housing shell can, for example, serve as a cover for the battery housing.

Furthermore, an object of the present invention is providing a traction battery which has improved temperature resistance and also low manufacturing costs.

This object underlying the present invention is solved by a traction battery with the features of claim 8. More specifically, this object is achieved by a traction battery for a motor vehicle, which is characterized in that the traction battery has a battery housing as described above.

Furthermore, an object of the present invention is providing a motor vehicle which has increased operational reliability while maintaining low costs of the battery system.

This object underlying the present invention is solved by a motor vehicle comprising the features of claim 9. More specifically, this object underlying the present invention is achieved by a motor vehicle which is characterized in that the motor vehicle comprises a traction battery as described above.

Furthermore, an object of the present invention is providing an extrusion tool for producing a battery housing shell formed as an extrusion part with a high-temperature-resistant protective device, wherein the manufacturing cost and the manufacturing time or cycle time for producing the battery housing shell is significantly reduced.

This object underlying the present invention is achieved by an extrusion tool for producing a battery housing shell formed as an extrusion part with the features of claim 10. Advantageous embodiments of the extrusion tool are described in the claims dependent on claim 10.

In more detail, this object underlying the present invention is achieved by an extrusion tool for producing a battery housing shell formed as an extruded part which is constructed as described above, wherein the extrusion tool has a die and a punch. The extrusion tool according to the invention is characterized in that the die and/or the punch comprises a receiving device for receiving a high-temperature-resistant protective device.

The method according to the invention comprises the advantage that an extrusion part in the form of a battery housing shell with increased heat resistance can be produced, wherein the production costs are considerably reduced due to the off-tool production of the extrusion part. Off-tool production of an extruded part is a manufacturing process in which the extrusion part can be produced without any subsequent manufacturing steps.

Due to the provision of the receiving device in the die of the extrusion tool, the protective device is reliably fixed during the molding of the battery housing shell, so that a melt front of a plastic material and/or a flow movement of the plastic material does not change the position of the protective device.

Preferably, the extrusion tool is designed such that the receiving device comprises at least one receiving recess in the die and/or in the punch for receiving a protective device.

The accordingly formed extrusion tool has the advantage that the positioning and fixing of the protective device in the die is made possible in a particularly simple manner.

Further preferably, the extrusion tool is formed such that the receiving device comprises at least two fixing recesses, each of which spans an edge of the receiving recess, wherein the fixing recesses have a greater depth than a depth of the receiving recess.

By appropriately designing the extrusion tool, the creation of the engagements or holding devices that engage the protective device from behind is made particularly easy.

Further preferably, the extrusion tool is formed such that the receiving device has at least two limits which protrude from a plane of the die and/or the punch and between which the protective device can be positioned.

The extrusion tool formed accordingly comprises the advantage that the positioning and fixing of the protective device in the die is made possible in a particularly simple manner.

Further preferably, the extrusion tool is formed such that the receiving device comprises at least two fixing recesses, each of which spans an edge of a receiving surface of the receiving device.

By appropriately designing the extrusion tool, the creation of the engagements or holding devices that engage the protective device from behind are made particularly easy.

Furthermore, an object of the present invention is providing a method of producing a battery housing shell formed as an extrusion part, wherein the battery housing shell is formed as described above, by means of which the extrusion part can be produced more easily and quickly.

This object underlying the present invention is solved by a method having the features of claim 15. More specifically, this object underlying the present invention is achieved by a method of producing a battery housing shell formed as an extrusion part by means of an extrusion tool according to one of the aforementioned examples, wherein the method comprises the following method steps:
Placing a protective device in the receiving device of the die and/or the punch of the extrusion tool;
Placing at least one plastic material in a die of the extrusion tool in the open position;
Closing the extrusion tool so that a stamp of the extrusion tool comes into contact with the at least one plastic material and the plastic material is deformed by applying pressure by means of the stamp and flows behind the protective device at least in sections of an outer edge of the protective device.

Further advantages, details and features of the invention will become apparent from the following exemplary embodiments. In detail:

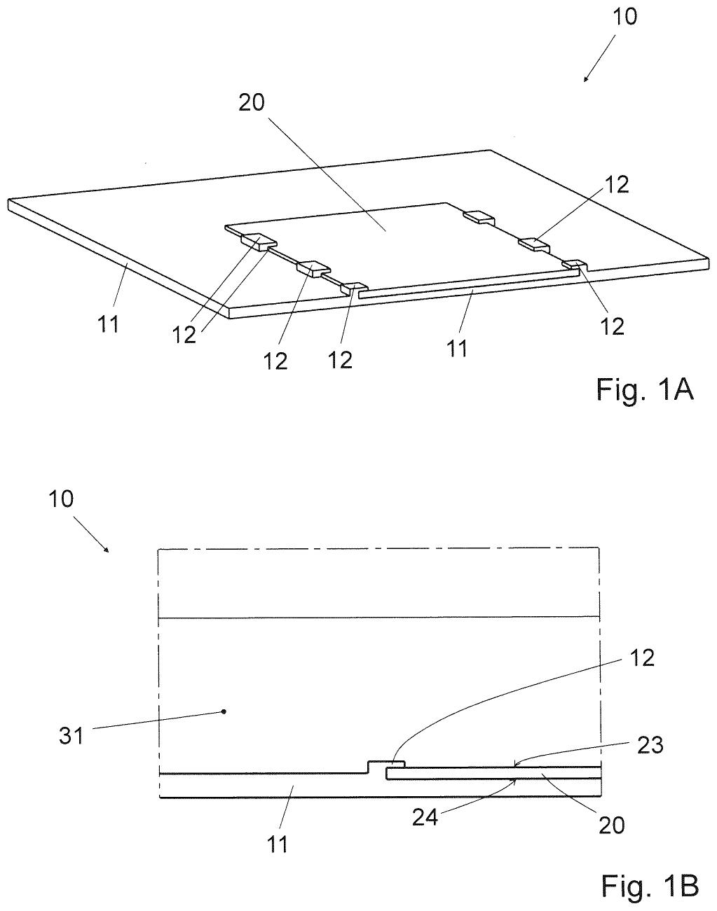

FIG. 1A: a perspective sectional view through a battery housing shell according to the invention;

FIG. 1B: a sectional view of the battery housing shell shown in FIG. 1A;

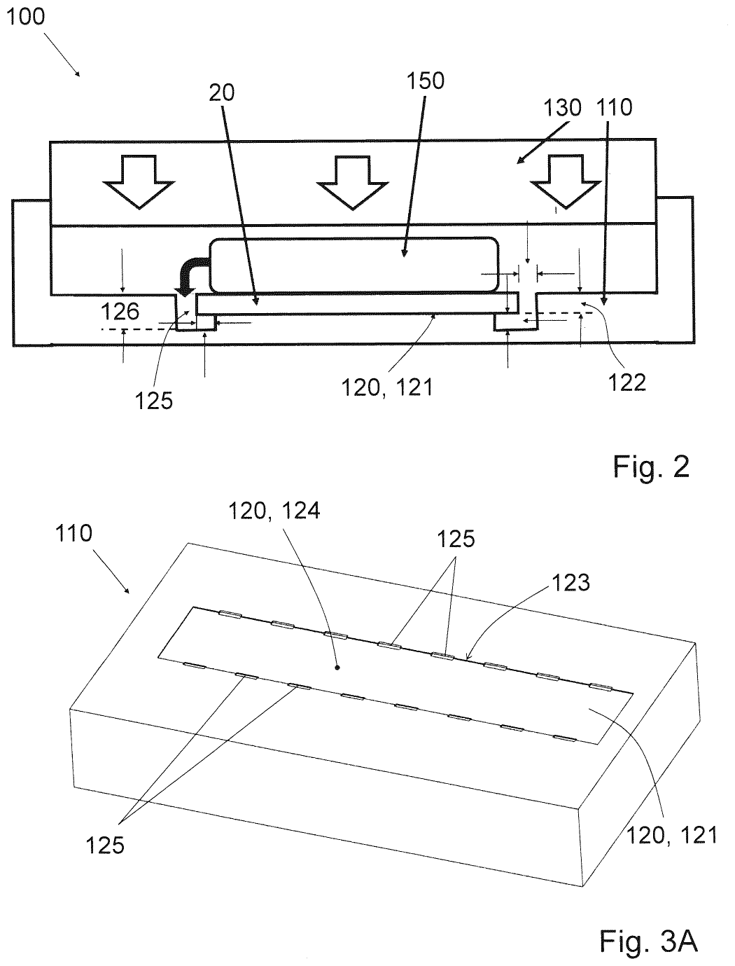

FIG. 2: a schematic cross-sectional view of an extrusion tool according to the invention;

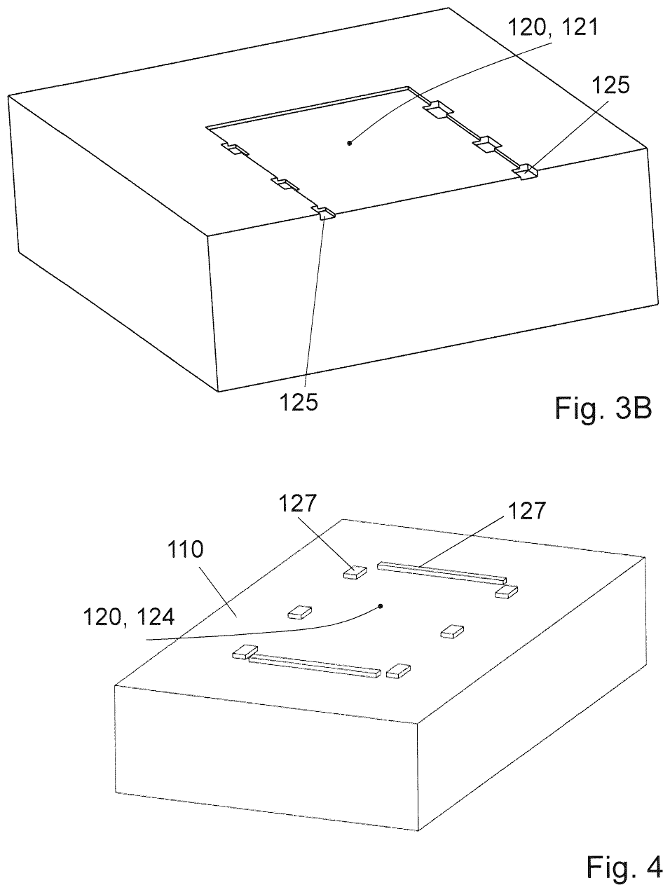

FIG. 3A: a perspective view of a die of an extrusion tool according to the invention, by means of which the battery housing shell shown in FIGS. 1A and 1B can be produced;

FIG. 3B: a sectional view through the die shown in FIG. 3A;

FIG. 4: a perspective view of a die of an extrusion tool according to a further embodiment of the present invention;

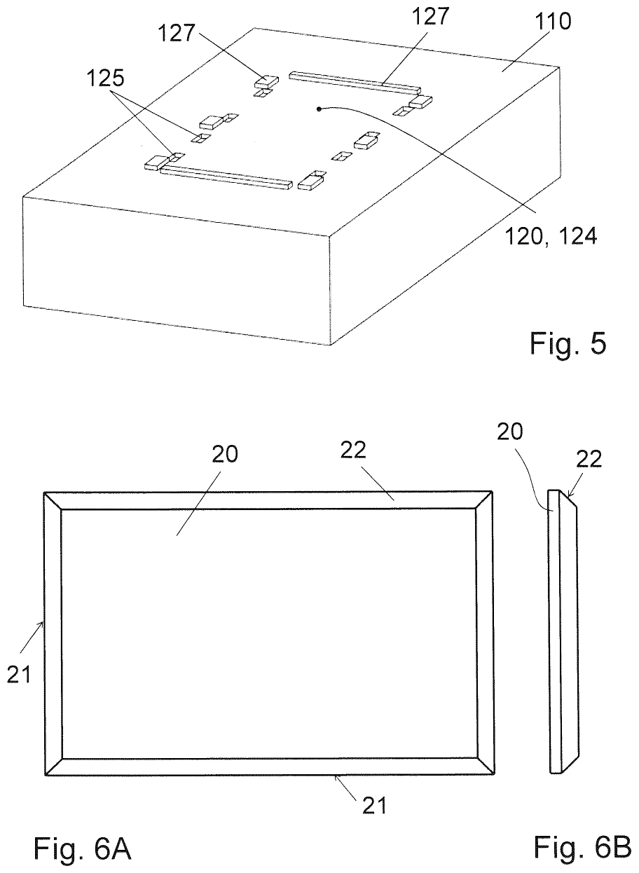

FIG. 5: a perspective view of a die of an extrusion tool according to yet another embodiment of the present invention;

FIG. 6A: a plan view of a high-temperature-resistant protective device which can be placed on the die shown in FIG. 4;

FIG. 6B: a side view of the high-temperature-resistant protective device shown in FIG. 6A;

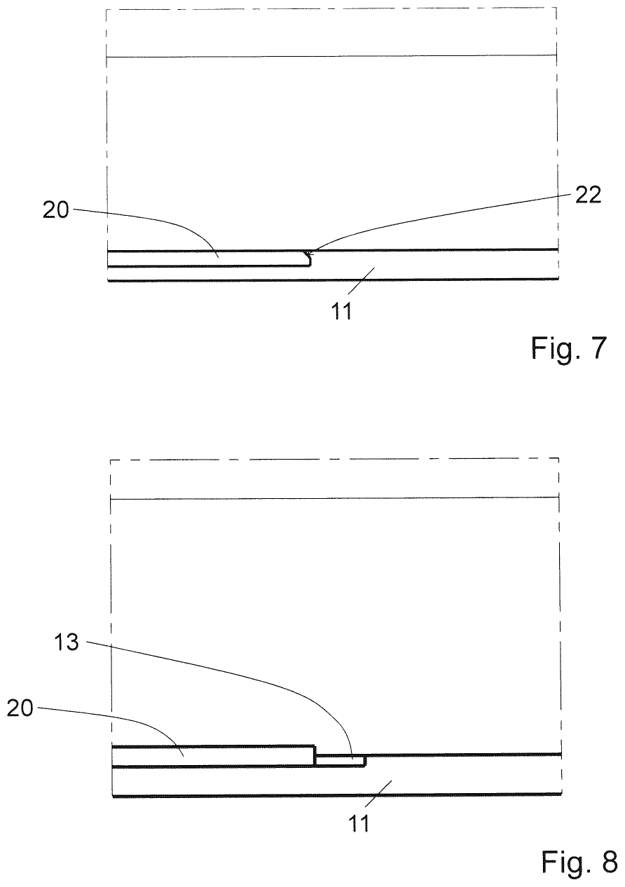

FIG. 7: a sectional view through a battery housing shell having the protective device shown in FIGS. 6a and 6B;

FIG. 8: a sectional view through a battery housing shell according to a further embodiment of the present invention;

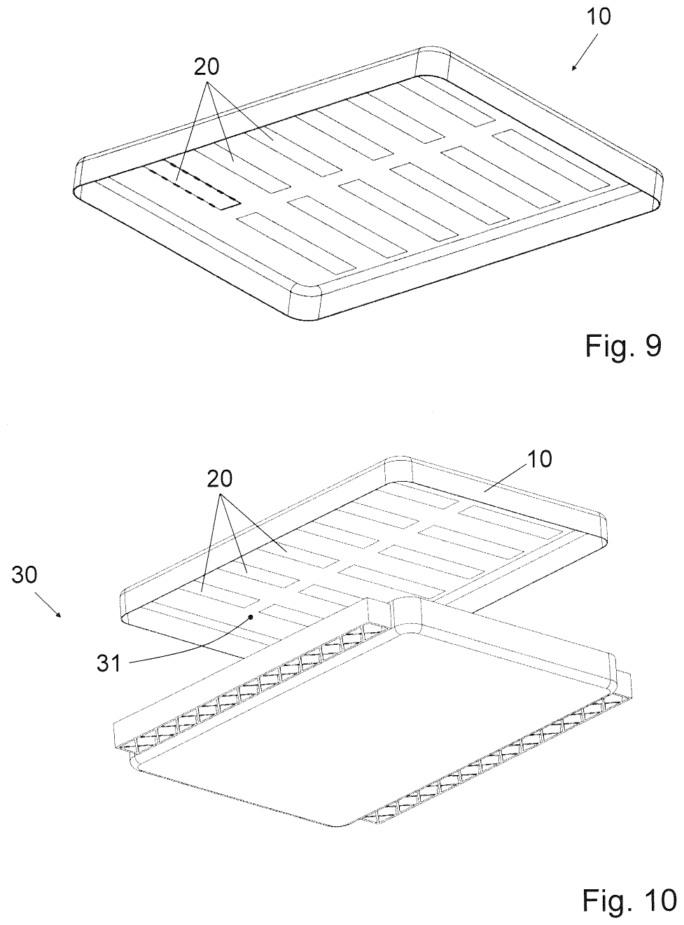

FIG. 9: a perspective view of a battery housing shell according to the invention;

FIG. 10: a perspective view of a battery housing according to the invention in the disassembled state, in which two battery housing shells are separated from each other;

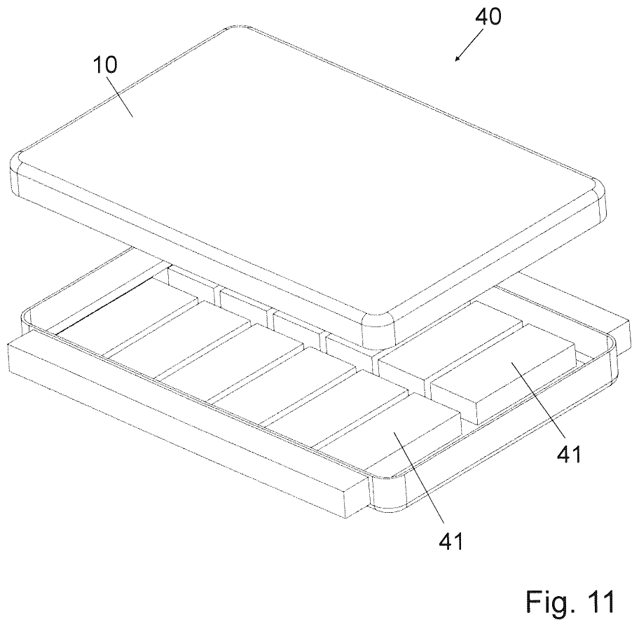

FIG. 11: a perspective view of a traction battery according to the invention, which comprises the battery housing shown in FIG. 10;

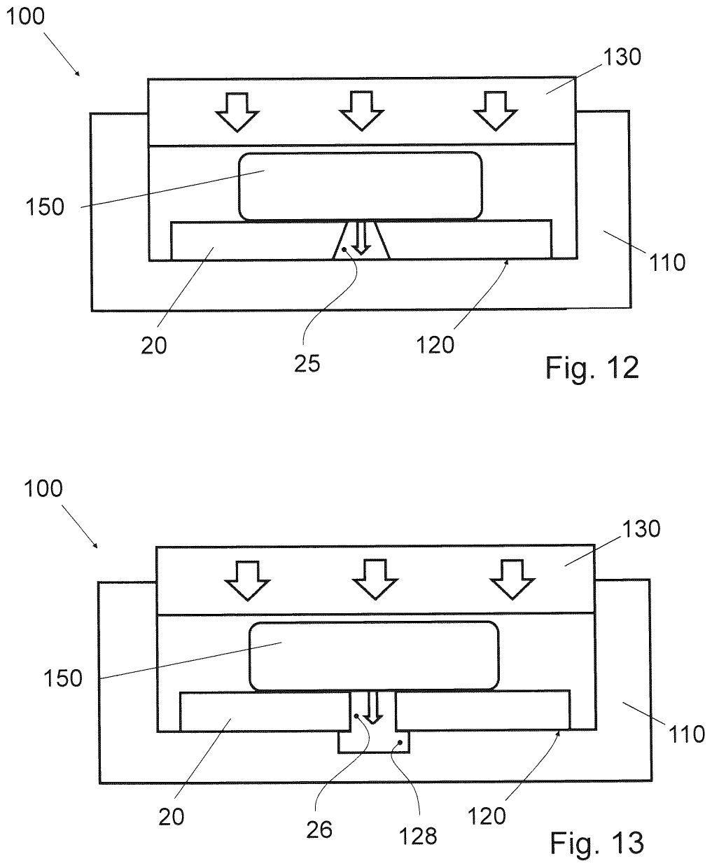

FIG. 12: a schematic cross-sectional view of an extrusion according to a further embodiment of the present invention for producing a battery housing shell according to a further embodiment of the present invention; and

FIG. 13: a schematic cross-sectional representation of an extrusion tool according to yet another embodiment of the present invention for producing a battery housing shell according to yet another embodiment of the present invention.

In the description that follows, the same reference symbols designate the same components or the same features, so that a description given in relation to one figure with respect to a component also applies to the other figures, thus avoiding a repetitive description. Furthermore, individual features that have been described in connection with one embodiment can also be used separately in other embodiments.

FIGS. 1A and 1B each show in section a battery housing shell 10 according to the invention for a battery housing 30 shown in FIG. 10 of a traction battery 40 shown in FIG. 11 for receiving at least one battery component 41 in a battery housing volume 31. It can be seen that a wall 11 of the battery housing shell 10 at least partially limits the battery housing volume 31. The wall 11 of the battery housing shell 10 is formed at least partially from a plastic which can be reinforced, for example, with fibres, in particular with long fibres.

From FIGS. 1A and 1B it can be seen that the battery housing shell 10 comprises a high temperature resistant protective device 20 which is at least partially form-fit engaged from behind by the wall 11 of the battery housing shell 10. In the embodiment of the battery housing shell 10 shown in FIGS. 1A and 1B, the latter comprises at least one holding device 12 formed monolithically with the wall 11. The holding device 12 is formed as a holding clip 12 and engages the protective device 20 from behind.

In the embodiment shown in FIGS. 1A and 1B, the protective device 20 is arranged on an inner side 23 of the wall 11 facing the battery housing volume 31. Of course, it is also possible for the protective device 20 to be arranged on an outer side 24 of the wall 11 facing away from the battery housing volume 31.

The protective device 20 can comprise a layered silicate and/or mica and/or metal and/or steel and/or plastic and/or fiber-reinforced plastic.

Since the protective device 20 is at least partially engaged from behind by the wall 11 of the battery housing shell 10, the protective device 20 is essentially not displaceable relative to the wall 11 of the battery housing shell 10. This means that the protective device cannot be moved or can only be moved in one direction by a few millimeters. For this purpose, as shown in FIG. 8, a free space 13 in the form of an expansion joint 13 can be provided between the protective device 20 and the wall 11, which allows a movement of the protective device 20 relative to the wall 11 in at least one direction, so that possibly different thermally induced expansions of the protective device material and the wall material can be compensated with little or no stress.

FIG. 7 shows a sectional view through a battery housing shell 10, which comprises a protective device 20 shown in FIGS. 6A and 6B. In the protective device 20 shown in FIGS. 6A and 6B, the entire outer edge 21 of the protective device 20 comprises a bevel 22. As can be seen from FIG. 7, the bevel 22 of the protective device 20 is at least partially engaged from behind by the wall 11, so that the protective device 20 is held by the wall 11.

For example, the outer edge 21 can be formed partially beveled, wherein the protective device 20 is engaged from behind by the wall 11 in the region of the beveled areas of the outer edge 21.

FIG. 2 shows a schematic cross-sectional view of an extrusion tool 100 according to the invention for producing a battery housing shell 10 designed as an extrusion part 10. The extrusion tool 100 has a die 110 and a punch 130. FIG. 3A shows a perspective view of a die 110 of the extrusion tool 100, by means of which the battery housing shell shown in FIGS. 1A and 1B can be produced. FIG. 3B shows a sectional view through the die 110 shown in FIG. 3A.

From FIGS. 2, 3A and 3B it can be seen that the die 110 has a receiving device 120, 121 for receiving a high-temperature-resistant protective device 20. In the embodiment shown in FIGS. 2, 3A and 3B, the receiving device 120, 121 has a receiving recess 121 which is formed to receive a protective device 20.

To produce a battery housing shell 10 designed as an extrusion part 10, a protective device (20) is placed in the receiving device 120, 121, 127 of the die 110 of the extrusion tool 100. Subsequently, at least one plastic material 150 is placed in the die 110 of the extrusion tool 100 which is in the open position. The plastic material 150 can be placed on the protective device 20 independently of the design of the die 110. Subsequently, the extrusion tool 100 is closed so that the punch 130 of the extrusion tool 100 comes into contact with the plastic material 150 and the plastic material 150 is deformed by applying pressure by means of the punch 130 and flows behind the protective device 20 at least in sections on an outer edge 21 of the protective device 20.

By placing the protective device 20 in the receiving recess 121, the position of the protective device in the die 110 is fixed even during an extrusion process, because melt fronts of the plastic material 150 cannot displace the protective device 20 relative to the die 110.

As can be seen from FIGS. 2, 3A, 3B and 5, the receiving device 120, 121 comprises at least two fixing recesses 125, each of which spans an edge 123 of the receiving recess 121. The fixing recesses 125 have a greater depth 126 than a depth 122 of the receiving recess 121. This ensures that in the battery housing shell 10 produced by means of the extrusion tool 100, the protective device 20 is at least partially engaged from behind by the wall 11 of the battery housing shell 10.

When using the die 110 shown in FIGS. 2, 3A, 3B and 5, a battery housing shell 10 as shown in FIGS. 1A and 1B is produced during the extrusion process, which comprises at least two holding devices 12 in the form of holding clips 12, which are each formed monolithically with the wall 11 of the battery housing shell 10.

When using the die 110 shown in FIG. 4 in an extrusion tool 100 and a protective device 20 as shown in FIGS. 6A and 6B, which comprises a bevel 22 at least in sections on its outer edge 21, a battery housing shell 10 as shown in FIG. 7 is produced. In this case, the bevel 22 of the protective device 20 is at least partially or completely engaged from behind by the wall 11 of the battery housing shell 10.

In the die 110 shown in FIG. 4, the receiving device 120, 127 has a plurality of limits 127, each of which protrudes from a plane of the die 110 and between which the protective device 20 can be positioned. The protective device 20 can be positioned on a receiving surface 124 of the receiving device 120 located between the limits 127.

The die 110 shown in FIG. 5 differs from the die shown in FIG. 4 in that the die shown in FIG. 5 comprises at least two and, in the embodiment shown, eight fixing recesses 125, each of which spans an edge of a receiving surface 124 of the receiving device 120.

When using the die 110 shown in FIG. 4 or the die 110 shown in FIG. 5 in an extrusion tool 100, a battery housing shell 10 is produced in which the at least one protective device 20 is embedded flatly in the wall 11 of the battery housing shell 10, so that the wall 11 together with the protective device 20 at least partially comprises a flat surface without unevenness.

When using a die 110 with a plurality of receiving devices 120 in an extrusion tool 100, wherein a protective device 20 is placed in/on each receiving device 120, a battery housing shell 10 as shown in FIG. 9 is produced, which comprises a plurality of protective devices.

FIG. 10 shows a perspective view of a battery housing 30 according to the invention in the disassembled state, in which two battery housing shells are separated from each other. The upper battery housing shell 10 comprises the plurality of high temperature resistant protective devices 10, and a plurality of battery components can be inserted in the lower battery housing shell, as shown in the traction battery 40 shown in perspective in FIG. 11.

FIG. 12 shows a schematic cross-sectional view of an extrusion tool 100 for producing a battery housing shell 10 designed as an extrusion part 10 according to a further embodiment of the present invention. The structure of the extrusion tool shown in FIG. 12 is very similar to that of the extrusion tool 100 shown in FIG. 2, so that reference is made to the above description in order to avoid repetition.

In the extrusion tool 100 shown in FIG. 12, the protective device 20 comprises at least one conical through hole 25 which is filled with material of the plastic material 150 during the manufacturing process of the battery housing shell 10, so that this material filling the conical through hole 25 forms the holding device of the wall 11 of the battery housing shell 10. Due to the conical design of the through hole 25, the holding device of the wall 11 engages the protective device 20 from behind.

Although not apparent from FIG. 12, the receiving device 120 of the extrusion tool 100 shown in FIG. 12 can have a receiving recess 121. This receiving recess 121 does not have to, but can, comprise fixing recesses 125 as shown in FIGS. 3A and 3B or 5. Furthermore, the extrusion tool 100 can be formed such that the die 110 has one or a plurality of limits 127, which are formed, for example, as in FIG. 4 or as in FIG. 5. Furthermore, the protective device 20 can have one or a plurality of bevels 22. With regard to the arrangement of the bevel 22 or the bevels 22, reference is made to the above explanations.

FIG. 13 shows a schematic cross-sectional view of an extrusion tool 100 for producing a battery housing shell 10 formed as an extrusion part 10 according to yet another embodiment of the present invention. The structure of the extrusion tool shown in FIG. 13 is very similar to that of the extrusion tool 100 shown in FIG. 2, so that reference is made to the above description in order to avoid repetition.

In the extrusion die 100 shown in FIG. 13, the protective device 20 comprises at least one through hole 26, which is filled with material of the plastic material 150 during the manufacturing process of the battery housing shell 10. The die 110 has a fixing recess 128. When the protective device 20 is positioned in/on the receiving device 120, the through hole 26 is arranged over the fixing recess 128, so that during the manufacturing process of the battery housing shell 10, the fixing recess 128 is also filled with material of the plastic material 150. Since the diameter of the fixing recess 128 is larger than the diameter of the through hole 26, the material filling the through hole 26 and the fixing recess 128 forms the holding device of the wall 11 of the battery housing shell 10, this holding device engaging the protective device 20 from behind.

Although not evident from FIG. 13, the receiving device 120 of the extrusion tool 100 shown in FIG. 13 may comprise a receiving recess 121. This receiving recess 121 need not, but may comprise fixing recesses 125, as shown in FIGS. 3A and 3B or 5. Furthermore, the extrusion tool 100 can be formed in such a way that die 110 has one or a plurality of limits 127, which are formed, for example, as in FIG. 4 or as in FIG. 5. Furthermore, the protective device 20 can have one or a plurality of bevels 22. With regard to the arrangement of the bevel 22 or bevels 22, reference is made to the above explanations.

### Reference Signs

10 Battery housing shell/Extrusion part
11 Wall
12 Holding device
13 free space/expansion joint
20 (high-temperature-resistant) Protective device
21 Outer edge
22 Bevel
23 Inner side
24 outer side
25 conical through hole
26 through hole
30 Battery housing
31 Battery housing volume
40 traction battery
41 battery component
100 Extrusion tool
110 die
120 Receiving device
121 Receiving recess
122 depth
123 edge
124 receiving surface
125 fixing recess
126 depth
127 limit
128 Fixing recess
130 punch
150 plastic material

1. A battery housing shell for a battery housing of a traction battery for accommodating at least one battery component in a battery housing volume, wherein a wall of the battery housing shell at least partially limits the battery housing volume, and wherein the wall of the battery housing shell is at least partially formed from a plastic, the battery housing shell comprising:
a high-temperature-resistant protective device,
wherein the protective device is at least partially form-fit engaged from behind by the wall of the battery housing shell.

2. The battery housing shell according to claim 1, characterized in that it comprises at least one holding device formed monolithically with the wall.

3. The battery housing shell according to claim 1, wherein:
an outer edge of the protective device at least partially comprises a bevel; and
the at least one bevel of the protective device is at least partially engaged from behind by the wall.

4. The battery housing shell according to claim 1, wherein at least one protective device is arranged on an inner side that is facing the battery housing volume and/or at least one protective device is arranged on an outer side of the wall of the battery housing shell that is facing away from the battery housing volume.

5. The battery housing shell according to claim 1, wherein the at least one protective device is embedded flatly in the wall of the battery housing shell, so that the wall comprises a flat surface without unevenness.

6. The battery housing shell according to claim 1, wherein the protective device comprises a layered silicate and/or mica and/or metal and/or steel and/or plastic and/or fiber-reinforced plastic.

7. Battery housing of a traction battery for accommodating at least one battery component in a battery housing volume, characterized in that the battery housing comprises a battery housing shell according to one of the preceding claims.

8. A traction battery for a motor vehicle, wherein the traction battery comprises a battery housing according to claim 7.

9. A motor vehicle comprising a traction battery according to claim 8.

10. An extrusion tool for producing a battery housing shell formed as an extrusion part according to claim 1, wherein the extrusion tool comprises a die and a punch, wherein the extrusion tool (100) is characterized in that the die and/or the punch comprises a receiving device for receiving a high-temperature-resistant protective device.

11. The extrusion tool according to claim 10, characterized in that the receiving device comprises at least one receiving recess in the die and/or in the punch for receiving a protective device.

12. The extrusion tool according to claim 11, wherein:
the receiving device comprises at least two fixing recesses, each of which span an edge of the receiving recess;
the fixing recesses comprise a greater depth than a depth of the receiving recess.

13. The extrusion tool according to claim 10, wherein the receiving device comprises at least two limits which protrude from a plane of the die and/or the punch and between which the protective device can be positioned.

14. The extrusion tool according to claim 13, wherein the receiving device comprises at least two fixing recesses, each of which span an edge of a receiving surface of the receiving device.

15. A method of producing a battery housing shell formed as an extrusion part by means of an extrusion tool according to claim 10, wherein the method comprises steps of:
placing a protective device in the receiving device of the die and/or the punch of the extrusion tool;
placing at least one plastic material in a die of the extrusion tool in an open position;
closing the extrusion tool so that a stamp of the extrusion tool comes into contact with the at least one plastic material and the plastic material is deformed by applying pressure by means of the stamp and flows behind the protective device at least in sections of an outer edge of the protective device.
